(19) United States
(12) Patent Application Publication
(10) Pub. No.: US 2026/0346893 A1
(43) Pub. Date: Nov. 5, 2026

(54) CARTS WITH FOLDABLE BRAKE SYSTEMS

(71) Applicant: Cannon Equipment LLC, Cannon Falls, MN (US)

(72) Inventors: Trent William Brossard, Red Wing, MN (US); Miraj Jayantibhai Thakkar, Eagan, MN (US); Sean Paul Grainger, Woodbury, MN (US)

(73) Assignee: Cannon Equipment LLC, Cannon Falls, MN (US)

(21) Appl. No.: 19/662,164

(22) Filed: Apr. 29, 2026

Related U.S. Application Data
(60) Provisional application No. 63/797,697, filed on Apr. 30, 2025.

(51) Int. Cl. B62B 5/04; B62B 3/00; B62B 3/02; B62B 3/14

(52) U.S. Cl. CPC B62B 5/0433; B62B 3/005; B62B 3/02; B62B 3/1404; B62B 5/0485

(57) ABSTRACT

A cart for transporting objects includes a rear wall, a first side structure coupled to the rear wall. The first side structure is movable to extend transverse to the rear wall when the cart is in a transport configuration and extend along the rear wall when the cart is in a stored configuration. A ground-engaging support element is coupled to the first side structure and configured to permit movement of the cart. A braking system is for selectively stopping rotation of the ground-engaging support element to thereby prevent movement of the cart. The braking system includes a link assembly movable into and between an extended position when the cart is in the transport configuration and a folded position when the cart is in the stored configuration.

### CROSS-REFERENCE TO RELATED APPLICATION

The present disclosure is based on and claims priority to U.S. Provisional Patent Application No. 63/797,697 filed Apr. 30, 2026, the disclosure of which is incorporated herein by reference.

### FIELD

The present disclosure relates to carts and specifically to carts that are nestable and for transporting objects.

### BACKGROUND

The following U.S. Patents are incorporated herein by reference in entirety.

U.S. Patent No. 5,873,204 discloses a cart having a base and three sidewalls extending there around and upward therefrom. Four wheels are secured at bottom corners of the sidewalls to provide for easy mobility of the cart. A pair of partial doors are hingedly secured to and extend along end edges of two opposing sidewalls for permitting partial coverage of a fourth side of the cart. Each partial door includes a spring biased manually operable pin for cooperating with a plurality of slots in the cart base. In this manner the doors can be positioned from an orientation substantially coextensive with a front edge of the cart base, to positions wherein the doors are oriented inwardly of the cart loading interior space.

U.S. Patent No. 9,428,205 discloses a security cart includes a rear wall, a wheeled base frame connected to the rear wall and a base shelf pivotable between a horizontal position and a raised position. A first sidewall and a first door pivotally connected to the first sidewall are movable from locked positions with the base shelf to a folded position forwardly of the rear wall. A second sidewall and a second door pivotally connected to the second sidewall are movable from locked positions to a folded position forwardly of the folded first sidewall and first door. The base shelf is movable from the horizontal position to the raised position, and retained against the folded first sidewall and the first door and the folded second sidewall and second door.

U.S. Patent No. 10,766,516 discloses a modular cart assembly that includes a first cart and an identical second cart. Each cart has a latching assembly that vertically slides along the cart and a coupling arm spaced apart from the latching assembly. The first cart is coupled to the second cart by positioning the first cart next to the second cart, vertically sliding the latching assembly of the first cart along the first cart until the latching assembly of the first cart couples to the coupling arm of the second cart, and vertically sliding the latching assembly of the second cart along the second cart until the latching assembly of the second cart couples to the coupling arm of the first cart.

U.S. Patent No. 11,110,947 discloses a cart for transporting objects has a base and a first end wall and an opposite second end wall extending from the base. A sidewall extends from the base and between the end walls such that the base, the first end wall, the second end wall, and the sidewall define an interior space of the cart. A hinge couples a door to the first end wall such that the door can be pivoted into different positions. One or more arms extend into the interior space to support and retain objects therein.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a cart for transporting objects includes a rear wall, a first side structure coupled to the rear wall. The first side structure is movable to extend transverse to the rear wall when the cart is in a transport configuration and extend along the rear wall when the cart is in a stored configuration. A ground-engaging support element is coupled to the first side structure and configured to permit movement of the cart. A braking system is for selectively stopping rotation of the ground-engaging support element to thereby prevent movement of the cart. The braking system includes a link assembly movable into and between an extended position when the cart is in the transport configuration and a folded position when the cart is in the stored configuration.

In certain examples, a cart for transporting objects includes a rear wall and a first side structure coupled to the rear wall, wherein the first side structure is movable to extend transverse to the rear wall when the cart is in a transport configuration and extend along the rear wall when the cart is in a stored configuration. A pair of ground-engaging support elements is coupled to the first side structure and configured to support the cart and permit movement of the cart. A braking system is for selectively stopping rotation of the ground-engaging support element to thereby prevent movement of the cart. The braking system includes a link assembly having a first link and a second link coupled to each other with a joint with the link assembly being movable into and between an extended position in which the first link and the second link extend along an axis when the cart is in the transport configuration and a folded position in which the first link extends along the axis and the second link extends transverse to the axis when the cart is in the stored configuration. A brake actuator is coupled to the link assembly and operable to rotate the first link and/or the second link. A first brake mechanism is coupled to the first link such that rotation of the first link causes the first brake mechanism to stop rotation of one of the ground-engaging support elements. A second brake mechanism is coupled to the second link such that rotation of the second link causes the second brake mechanism to stop rotation of the other ground-engaging support element.

In certain examples, a braking system for a foldable cart having a ground-engaging support element, a rear wall, and a side structure that is pivotable relative to the rear wall includes a link assembly including a first link, a second link, and a joint connecting the first link to the second link. A first brake mechanism is coupled to the first link and configured to selectively slow or stop rotation of the ground-engaging support element. A brake actuator is configured to be selectively driven by an operator to thereby rotate the first link and/or the second link such that rotation of the first link causes the first brake mechanism to slow or stop rotation of the ground-engaging support element. The link assembly is movable into and between an extended position in which the first link and the second link extend along an axis and a folded position in which the first link extends along the axis and the second link extends transverse to the axis. A second brake mechanism is coupled to the second link and configured to selectively slow or stop the rotation of another ground-engaging support element of the cart.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of an example cart according to the present disclosure.

FIG. 2 is an enlarged view of example rolling support assemblies and an example brake system according to the present disclosure.

FIG. 3 is an enlarged view within line 3-3 in FIG. 2.

FIG. 4 is a perspective view of an example brake system according to the present disclosure.

FIG. 5 is a top-down schematic view of two example carts according to the present disclosure in stored configurations and side-by-side.

FIG. 6 is a top-down schematic view of two example carts according to the present disclosure in stored configurations and nested with each other.

FIG. 7 is an enlarged perspective view of an example cart according to the present disclosure in the transport configuration.

FIG. 8 is an enlarged perspective view of the cart in an intermediate configuration.

FIG. 9 is an enlarged perspective view of the cart in the stored configuration.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

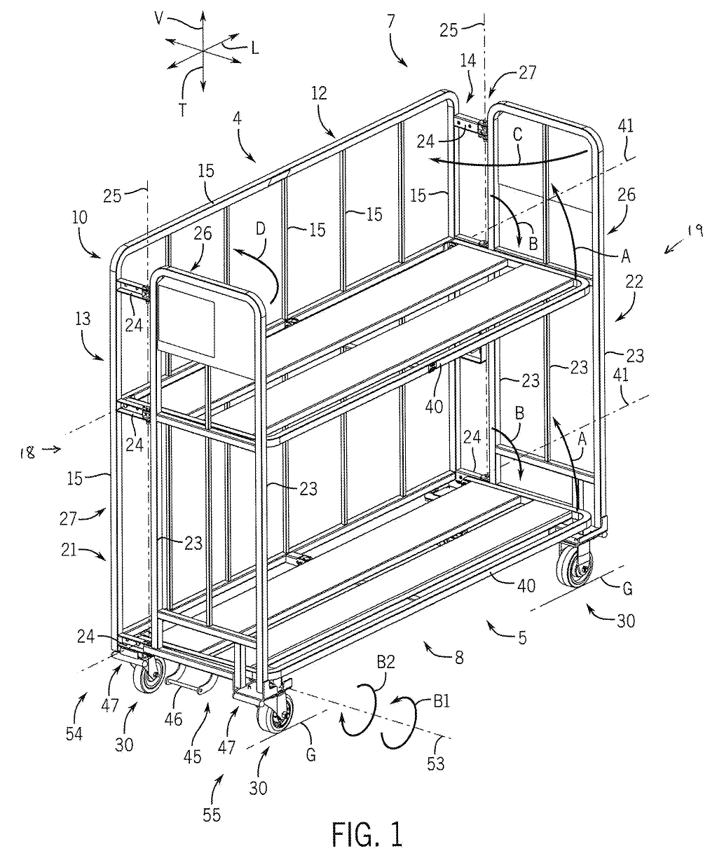

An example cart 10 according to the present disclosure is depicted in FIG. 1-4. The cart 10 generally includes a rear wall 12 extending between a first side 18 and a second side 19. The cart 10 includes one or more foldable shelves 40. The cart 10 longitudinally (see example axis L) extends between the sides 18, 19, laterally (see example axis T) between a rear 4 and a front 5, and vertically (see example axis V) between a top 7 and a bottom 8. These components and other related components and features of the cart 10 are described in greater detail below.

The rear wall 12 includes a plurality of frame members 15 that structurally support and define the extent of the rear wall 12. The frame members 15 also prevent objects in the cart 10 from passing through the rear wall 12. The rear wall 12 includes a first rear end 13 and a second rear end 14.

The first rear end 13 is coupled to a first side structure 21 at the first side 18 and the second rear end 14 is coupled to a second side structure 22 at the second side 19. The side structures 21, 22 can laterally extend away from the rear wall 12 in a direction from the rear 4 to the front 5. Note that the first side structure 21 is described in greater detail herein below, and the second side structure 22 can include any of the features and/or components described with reference to the first side structure 21 albeit some of the features and/or components may be reversed, mirrored, or inverted due to the position of the second side structure 22.

The first side structure 21 includes a plurality of frame members 23 that structurally support and define the extents of the first side structure 21. The first side structure 21 includes a plurality of brackets 24 that are coupled to the rear wall 12. The bracket(s) 24 define a vertically extending bracket pivot axis 25 about which a panel section 26 of the first side structure 21 pivots relative to a stationary section 27 of the first side structure 21 (described in greater detail herein). The stationary panel 27 is fixed relative to the rear wall 12.

The first side structure 21 includes one or more rolling support assemblies 30 that engage the ground G. Each rolling support assembly 30 includes one or more ground-engaging support elements, such as casters, wheels, rollers, or other rolling elements, that can be fixed or rotatable about one or more axes. In the example depicted, the rolling support assembly 30 includes ground-engaging support elements being wheels 31. The rolling support assembly 30 also includes a swivel bracket 32 that is coupled to one or more of the frame members 23. One or more of the rolling support assemblies 30 are coupled to the panel section 26 and the other rolling support assembly 30 is coupled to the stationary section 27. Note that the rolling support assembly 30 coupled to the stationary section 27 does not move laterally or longitudinally relative to the rear wall 12.

A braking system 45 is coupled to the first side structure 21 and is for selectively preventing movement of the wheels 31 and thereby disabling movement of the cart 10. The braking system 45 is coupled to the rolling support assemblies 30 and includes a brake actuator, which in this example is a brake pedal 46, that can be engaged by the operator of the cart 10 (described in greater detail herein).

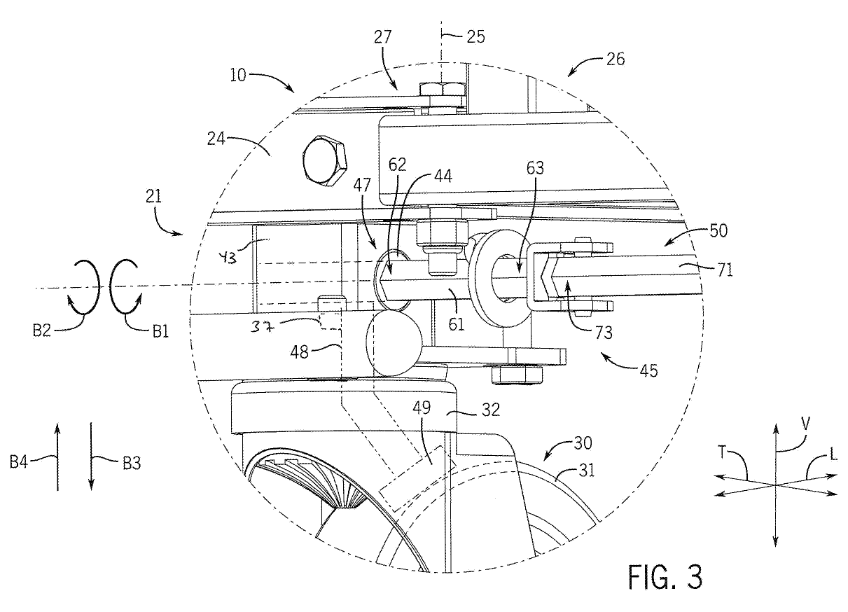

The braking system 45 includes a pair of brake mechanisms 47 (see FIG. 3). A brake mechanism 47 is located adjacent to each of the rolling support assemblies 30 along the first side structure 21 with one brake mechanism 47 coupled to the panel section 26 of the first side structure 21 and one brake mechanism 47 is coupled to the stationary section 27 of the first side structure 21.

Each brake mechanism 47 includes a body 43, a plunger 48 (see dash‑double‑dot lines in FIG. 3), a cam element 44 (see also dashed lines in FIG. 3) that engages the plunger 48, and a brake pad 49 (see dash‑double-dot lines in FIG. 3) coupled to the plunger 48 for selectively engaging the wheel 31. The operation of the cam element 44, the plunger 48, and the brake pad 49 are described further herein.

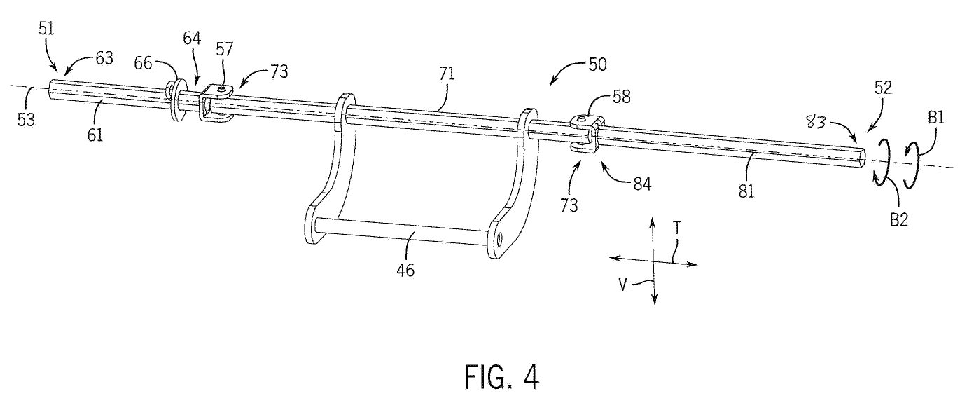

The braking system 45 includes a link assembly 50 (see FIG. 4) that extends between the pair of brake mechanisms 47 at the first side structure 21. The link assembly 50 has a first assembly end 51 and a second assembly end 52. The link assembly 50 includes a plurality of links that extend between the assembly ends 51, 52. The shape and/or type of link can vary. Although the links are described herein below as rods, the links may include one or more shafts, bars, lever arms, articulated members, telescoping members, cables, chains, belts, flexible shafts, tubes, and/or the like force‑ or torque‑transmitting elements, which may be rigid or flexible, and can be for transmitting motion through rotation, translation, or a combination thereof.

In the example depicted, the link assembly 50 exemplarily includes links that are rods 61, 71, 81 extending between the assembly ends 51, 52. Note that FIG. 4 depicts the rods 61, 71, 81 aligned along a laterally extending axis 53 when link assembly 50 is in an extended position and the cart 10 is in a transport configuration (see also FIG. 1). The rods 61, 71, 81 specifically include a first rod 61, a second rod 71, and a third rod 81. The rods 61, 71, 81 are depicted in FIG. 4 as having a hexagonal cross-sectional shape (e.g., the rods are hex-rods), however, in other examples, the rods 61, 71, 81 can have different cross-sectional shapes, such as circular or triangular. A washer 66 is located between the first end 63 and the second end 64.

The first rod 61 has a first end 63 and a second end 64. The first end 63 is received into the cam element 44 of the brake mechanism 47 located toward the rear 4 of the cart 10 (see arrow 54 for the location of the brake mechanism 47 at the rear 4 of the cart 10). A first joint 57 couples the second end 64 to one of the ends 73 of the second rod 71. The first joint 57 is configured to allow the first rod 61 to move relative to the second rod 71 and to transfer rotational forces between the first rod 61 and the second rod 71 (described further herein). In certain examples, the first joint 57 includes a U-joint or a universal joint, a cardan joint, a hinge, clevis, a knuckle, slip joint, ball-and-socket joint, spherical joint, and/or a flexible coupling.

The third rod 81 has a first end 83 and a second end 84. The first end 83 is received into the cam element 44 of the brake mechanism 47 distal from the rear wall 12 (see arrow 55 for the location of the brake mechanism 47 distal from the rear wall 12) at the front 5 of the cart 10 when the cart 10 is in the transport configuration. A second joint 58 couples the second end 84 to the other of the ends 73 of the second rod 71. The second joint 58 is configured to allow the third rod 81 to move relative to the second rod 71 and to transfer rotational forces to be transferred between the third rod 81 and the second rod 71 (described further herein). In certain examples, the second joint 58 includes a U-joint or a universal joint, a cardan joint, a hinged joint, a clevis joint, a knuckle joint, a slip joint, a ball-and-socket joint, a spherical joint, and/or a flexible coupling

The second rod 71 extends between the opposing ends 73, and the brake pedal 46 is coupled to the second rod 71 between the opposing end 73. The brake pedal 46 is coupled to the second rod 71 such that the movement of the brake pedal 46 causes rotation of the second rod 71 (described further herein).

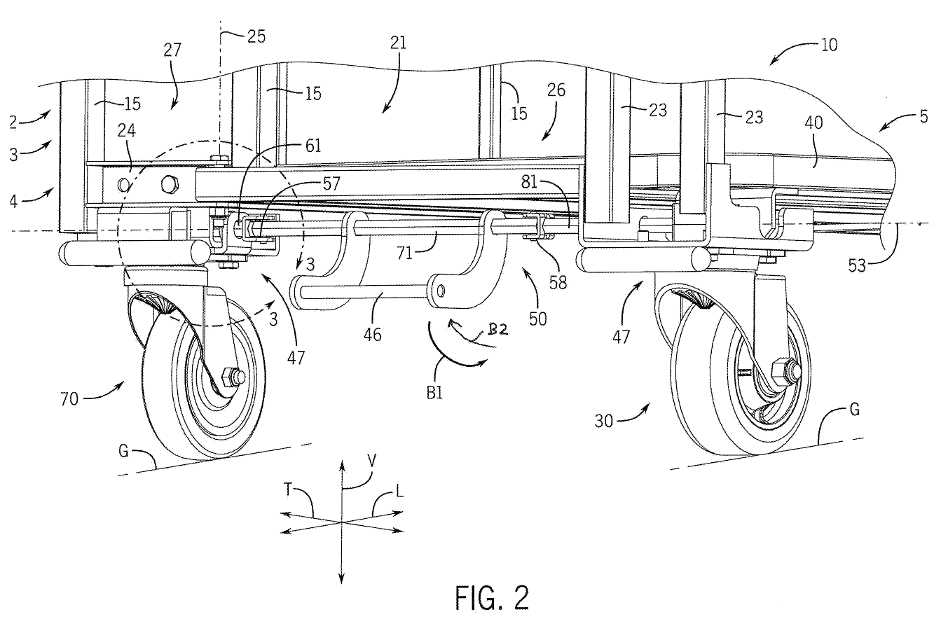

An example braking operation of the cart 10 is described hereinbelow. To cause the braking system 45 to slow or stop movement of the wheels 31 and thereby slow or stop movement of the cart 10, the operator controlling and moving the cart 10 engages the brake pedal 46 with their foot. Specifically, the operator moves the brake pedal 46 in a first direction (arrow B1 in FIG. 2) about the axis 53. The brake pedal 46 rotates the second rod 71 in the first direction, and the second rod 71 rotates the first rod 61 and the third rod 81 in the first direction via the joints 57, 58, respectively. Rotation of the first rod 61 and the third rod 81 in the first direction causes the cam element 44 in each brake mechanism 47 to cam the plungers 48 and the brake pads 49 toward the wheels 31 (see arrow B3 in FIG. 3). As such, the brake pad 49 slows or stops rotation of the wheel 31 with pressure forces and/or frictional forces. In certain examples, the braking system 45 remains in the ‘braked’ position after the operator removes their foot from the brake pedal until the operator reengages the brake pedal 46.

To disengage the braking system 45 and thereby permit movement of the cart 10, the operator uses their foot to move the brake pedal 46 in a second direction (arrow B2 in FIG. 2) about the axis 53. The brake pedal 46 rotates the second rod 71 in the second direction, and the second rod 71 rotates the first rod 61 and the third rod 80 in the second direction via the joints 57, 58, respectively. Rotation of the first rod 61 and the third rod 81 in the second direction causes the cam element 44 in each brake mechanism 47 to cause the plunger 48 to retract and the brake pad 49 away from the wheel 31 (see arrow B4 in FIG. 3). As such, the brake pad 49 no longer engages the wheel 31 and the wheel 31 can rotate. The link assembly 50 transfers torque from the brake pedal 46 to the brake mechanisms 47.

Note that in other examples, the operator may move their foot off the brake pedal 46 and a return device 37 (e.g., spring, elastic member) moves the plunger 48, the brake pad 49, cam element 44, and/or the link assembly 50 such that the rods 61, 71, 81 rotate in the second direction (arrow B2). Also note that in other examples, the second rod 71 can be rotated by another brake actuator and/or body parts of the operator. For instance, the second rod 71 is coupled to a pull handle mounted on the first side structure 21 for engagement by hand of the operator. In another example, the brake actuator is a motor or linear actuator that is actuated by the operator to thereby rotate the second rod 71.

Returning specifically to FIG. 1, the cart 10 also includes one or more shelves 40 on which objects can be supported. Each shelf 40 extends between the side structures 21, 22. Each shelf 40 is pivotable about a shelf axis 41 relative to the rear wall 12 and the side structures 21, 22. The two shelves 40 depicted in FIG. 1 are in the lowered positions such that objects can be loaded onto and vertically supported by the shelves 40. Objects are placed onto the shelves 40 from the front 5 of the cart 10. In the lowered positions, the shelves 40 are generally in horizontal orientation and extend parallel to each other.

Each shelf 40 is movable into a raised position (not depicted) such that the shelf 40 extends along the rear wall 12. In certain examples, the shelf 40 in the raised position extends parallel to the rear wall 12. Arrow A in FIG. 1 schematically depicts pivoting the shelf 40 about the corresponding shelf axis 41 in a first direction such that the shelf 40 is moved from the lowered position to the raised position. A lock or latch (not depicted; e.g., spring pin) can hold the shelf 40 in the raised position and a retainer bracket (not depicted; “L” shaped angle) prevents rotation of the shelf 40 past the lowered position. Arrow B in FIG. 1 schematically depicts pivoting the shelf 40 about the corresponding shelf axis 41 in a second direction such that the shelf 40 is moved from the raised position to the lowered position.

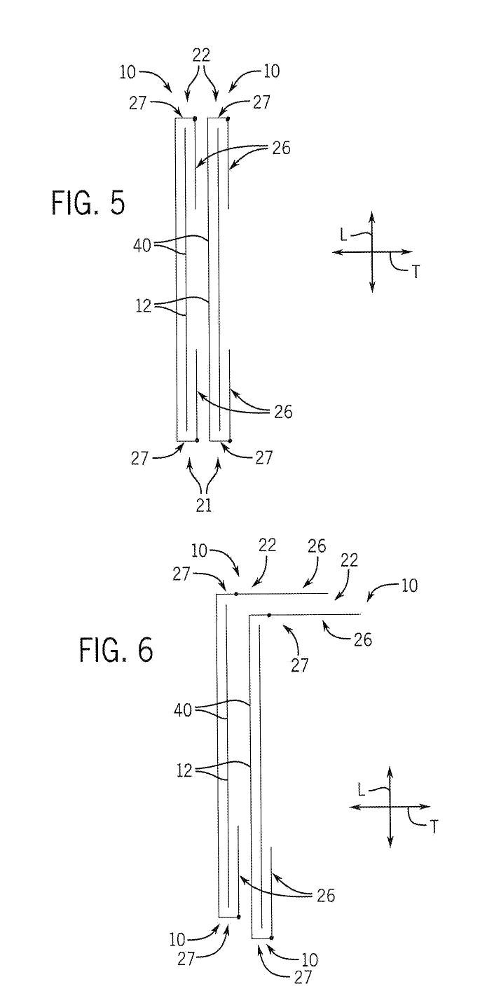

The cart 10 is configured to be moved from the transport configuration (FIG. 1) in which the cart 10 can be loaded with objects (e.g., boxes, packages) to a stored configuration (see FIGS. 5-6) in which the cart 10 can be nested with other similar carts 10.

To move the cart 10 from the transport configuration (FIG. 1) to the stored configuration, the operator pivots the shelves 40 from the lowered positions and the raised positions. The shelves 40 are moved to the raised positions by pivoting each shelf 40 about the respective pivot axis 41 in the first direction (arrow A in FIG. 1).

Next, the panel section 26 of the second side structure 22 is then pivoted (see arrow C on FIG. 1) about the bracket pivot axes 25 of the brackets 24 located at the second side structure 22. As such, the panel section 26 of the second side structure 22 extends along the rear wall 12. In certain examples, the panel section 26 of the second side structure 22 extends parallel to the rear wall 12 when the cart 10 is in the stored configuration. The panel section 26 is offset from the rear wall 12 by the stationary section 27. Note that the rolling support assembly 30 and the brake mechanism 47 coupled to the stationary section 27 of the second side structure 22 does not move with the panel section 26. However, the rolling support assembly 30 and the brake mechanism 47 coupled to the panel section 26 of the second side structure 22 do move with the panel section 26.

The operator then pivots the first side structure 21 (see arrow D in FIG. 1) about the bracket pivot axes 25 of the brackets 24 located at the first side structure 21. As such, the first side structure 21 extends along the rear wall 12. In certain examples, the first side structure 21 extends parallel to the rear wall 12 when the cart 10 is in the stored configuration. Note that the rolling support assembly 30 and the brake mechanism 47 coupled to the stationary section 27 of the first side structure 21 do not move with the panel section 26 while the rolling support assembly 30 and the brake mechanism 47 coupled to the panel section 26 of the first side structure 21 do move with the panel section 26.

As such, the cart 10 is in the stored configuration and has a smaller overall footprint than the cart 10 in the transport configuration. The cart 10 can be nested or located side-by-side with other similar carts 10 and occupy less space than the carts 10 in the transport configuration and arranged adjacent to each other. FIG. 5 schematically depicts two example carts 10 in the stored positions located side-by-side. FIG. 6 schematically depicts two example carts 10 in the stored positions in which the second side structure 22 is not folded into a position along the rear wall 12 and the carts 10 nest together.

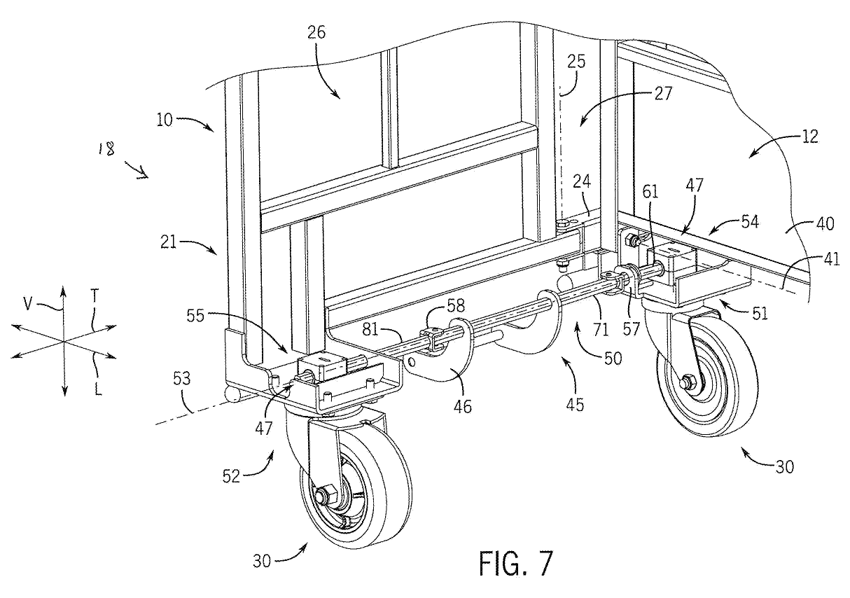

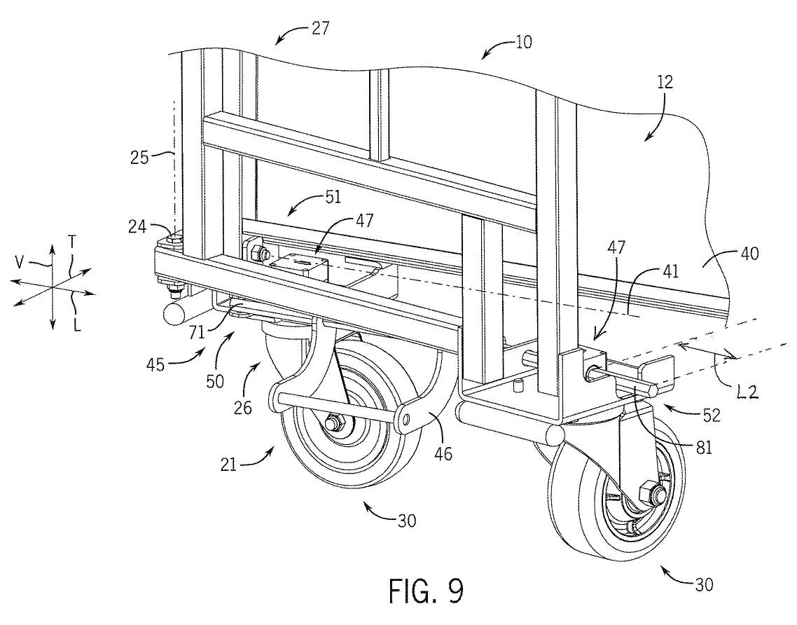

Referring now to FIGS. 7-9, folding of the braking system 45 as the cart 10 is moved into and between the transport configuration (FIG. 1) and the stored configuration is depicted. Specifically, the braking system 45 is movable into and between the extended position (see FIGS. 1 and 7) and a folded position (FIG. 9) as the cart 10 is moved into and between the stored configuration and the transport configuration, as described above. The present inventors recognized that the braking system 45 should be foldable and movable into different positions as the first side structure 21 is moved (as described above) to permit the cart 10 to be folded while also providing an easy method to engage and disengage the braking system 45 with a single brake pedal 46.

FIG. 7 depicts the cart 10 in the transport configuration (see also FIG. 1) such that the first side structure 21 extends transverse to the rear wall 12. The rods 61, 71, 81 of the braking system 45 extend along the axis 53. As such, the operator can operate the cart 10 and selectively engage the brake pedal 46 to brake the cart 10, as described above. Note that in certain examples, the third rod 81 may extend an initial length from the brake mechanism 47 when the cart 10 is in the transport configuration (see FIG. 7).

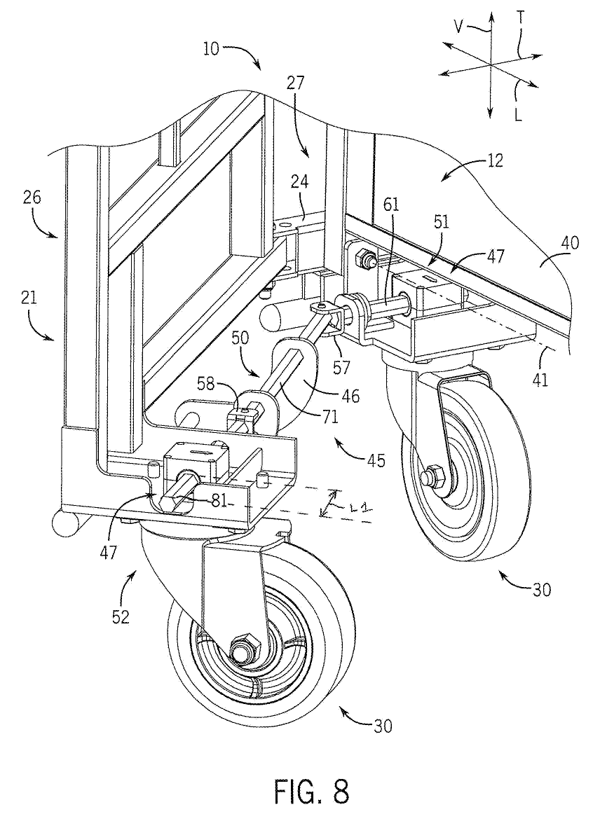

FIG. 8 depicts the first side structure 21 pivoted into an intermediate configuration between the transport configuration (FIG. 7) and the stored configuration (FIG. 9). The first rod 61 continues to extend along the axis 53, however, the second rod 71 and the third rod 81 are pivoted about the first joint 57 such that the second rod 71 and the third rod 81 do not align with the axis 53 and extend transverse to the axis 53. In certain examples, the third rod 81 also pivots relative to the second rod 71 about the second joint 58. As the first side structure 21 is moved, the third rod 81 is moved such that the third rod 81 extends from the brake mechanism 47. In the intermediate position, the third rod 81 extends a first length L1 from the brake mechanism 47. As such, the brake mechanism 47 is axially slidably coupled to the third rod 81 such that the third rod 81 is slidable through the brake mechanism 47 as described herein.

FIG. 9 depicts the cart 10 moved into the stored configuration with the first side structure 21 along the rear wall 12. The link assembly 50 is in the folded position in which at least one of the rods extends transverse to the other rods. For example, the first rod 61 continues to extend along the axis 53, however, the second rod 71 and the third rod 81 are pivoted further about the first joint 57 such that the second rod 71 and the third rod 81 remain misaligned with the axis 53 and extend transverse to the axis 53 and the first rod 61. The third rod 81 is moved such that the third rod 81 extends from the brake mechanism 47 a second length L2 from the brake mechanism 47. The second length L2 is greater than the first length L1. In one example, the first length is two inches and the second length is four inches.

When the cart 10 is moved from the stored configuration (FIG. 9) to the transport configuration (FIG. 7), the first side structure 21 is moved such that the rods 61, 71, 81 of the braking system 45 are moved into the positions depicted in FIG. 7 such that the rods 61, 71, 81 again extend along the axis 53. Note that as the first side structure 21 is moved, the third rod 81 is retracted toward the brake mechanism 47.

The following clauses set out features of the invention which may not be presently claimed but which may form the basis for amendments or future divisional applications or continuation applications.

Clause 1. A cart for transporting objects, the cart comprising:
a rear wall;
a first side structure coupled to the rear wall, wherein the first side structure is movable to extend transverse to the rear wall when the cart is in a transport configuration and extend along the rear wall when the cart is in a stored configuration;
a ground-engaging support element coupled to the first side structure and configured to permit movement of the cart;
a braking system for selectively stopping rotation of the ground-engaging support element to thereby prevent movement of the cart, the braking system including a link assembly movable into and between:
   an extended position when the cart is in the transport configuration; and
   a folded position when the cart is in the stored configuration.

Clause 2. The cart according to clause 1, wherein the link assembly includes a first link and a second link, and wherein in the extended position, the first link and the second link extend along an axis and wherein in the folded position, the second link extends transverse to the axis.

Clause 3. The cart according to clauses 1 or 2, wherein the braking system includes a first joint that couples the first link to the second link, wherein the first joint is configured to allow for transfer of rotation forces between the first link and the second link.

Clause 4. The cart according to any one of the preceding clauses, wherein the first side structure includes a stationary section fixed relative to the rear wall and a movable panel section that is pivotable relative to the stationary section about an axis.

Clause 5. The cart according to any one of the preceding clauses, wherein the braking system includes a brake mechanism and a brake actuator; and
wherein the link assembly transfers torque from the brake actuator to the brake mechanism to slow or stop rotation of the ground-engaging support element.

Clause 6. The cart according to clause 5, wherein the brake actuator is a brake pedal.

Clause 7. The cart according to any one of the preceding clauses, wherein the brake actuator rotates at least one link in the link assembly.

Clause 8. The cart according to any one of the preceding clauses, wherein the brake mechanism includes a plunger that is moved to apply a brake pad to the ground-engaging support element.

Clause 9. The cart according to any one of the preceding clauses, wherein the braking system includes a return device configured to bias the braking system toward an unbraked state.

Clause 10. The cart according to any one of the preceding clauses, wherein the first side structure includes a stationary section fixed relative to the rear wall and a movable panel section that is pivotable relative to the stationary section about an axis;
wherein the brake mechanism is a first brake mechanism coupled to the stationary section; and
wherein the braking system includes a second brake mechanism coupled to the panel section for selectively stopping the rotation of another ground-engaging support element.

Clause 11. The cart according to any one of the preceding clauses, wherein the link assembly includes a first rod, a second rod, and a joint connecting the first rod to the second rod.

Clause 12. The cart according to clause 11, wherein the joint includes a universal joint.

Clause 13. The cart according to any one of the preceding clauses, wherein the braking system includes a brake mechanism and the link assembly includes at least one link axially slidable through the brake mechanism.

Clause 14. The cart according to clause 13, wherein length of the at least one link extending from the brake mechanism increases as the link assembly is moved from the extended position toward the stored configuration.

Clause 15. The cart according to any one of the preceding clauses, further comprising at least one shelf supported on the rear wall and pivotable about a shelf axis between a lowered position for supporting objects thereon and a raised position adjacent the rear wall.

Clause 16. A cart for transporting objects, the cart comprising:
a rear wall;
a first side structure coupled to the rear wall, wherein the first side structure is movable to extend transverse to the rear wall when the cart is in a transport configuration and extend along the rear wall when the cart is in a stored configuration;
a pair of ground-engaging support elements coupled to the first side structure and configured to support the cart and permit movement of the cart;
a braking system for selectively stopping rotation of the ground-engaging support element to thereby prevent movement of the cart, the braking system including:
   a link assembly having a first link and a second link coupled to each other with a joint, the link assembly being movable into and between:
      an extended position in which the first link and the second link extend along an axis when the cart is in the transport configuration; and
         a folded position in which the first link extends along the axis and the second link extends transverse to the axis when the cart is in the stored configuration;
      a brake actuator coupled to the link assembly and operable to rotate the first link and/or the second link;
      a first brake mechanism coupled to the first link such that rotation of the first link causes the first brake mechanism to stop rotation of one of the ground-engaging support elements; and
      a second brake mechanism coupled to the second link such that rotation of the second link causes the second brake mechanism to stop rotation of the other ground-engaging support element.

Clause 17. The cart according to clause 16, wherein the joint is configured to allow for the transfer of rotation forces between the first link and the second link.

Clause 18. The cart according to clause 16 or 17, wherein the second link is axially slidable through the second brake mechanism.

Clause 19. A braking system for a foldable cart having a ground-engaging support element, a rear wall, and a side structure that is pivotable relative to the rear wall, the braking system comprising:
a link assembly including a first link, a second link, and a joint connecting the first link to the second link;
a first brake mechanism coupled to the first link and configured to selectively slow or stop rotation of the ground-engaging support element; and
a brake actuator configured to be selectively driven by an operator to thereby rotate the first link and/or the second link such that rotation of the first link causes the first brake mechanism to slow or stop rotation of the ground-engaging support element;
   wherein the link assembly movable into and between:
      an extended position in which the first link and the second link extend along an axis; and
      a folded position in which the first link extends along the axis and the second link extends transverse to the axis.

Clause 20. The braking system according to clause 19, a second brake mechanism coupled to the second link and configured to selectively slow or stop the rotation of another ground-engaging support element of the cart.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A cart for transporting objects, the cart comprising:
a rear wall;
a first side structure coupled to the rear wall, wherein the first side structure is movable to extend transverse to the rear wall when the cart is in a transport configuration and extend along the rear wall when the cart is in a stored configuration;
a ground-engaging support element coupled to the first side structure and configured to permit movement of the cart;
a braking system for selectively stopping rotation of the ground-engaging support element to thereby prevent movement of the cart, the braking system including a link assembly movable into and between:
an extended position when the cart is in the transport configuration; and
a folded position when the cart is in the stored configuration.

2. The cart according to claim 1, wherein the link assembly includes a first link and a second link, and wherein in the extended position, the first link and the second link extend along an axis and wherein in the folded position, the second link extends transverse to the axis.

3. The cart according to claim 2, wherein the braking system includes a first joint that couples the first link to the second link, wherein the first joint is configured to allow for transfer of rotation forces between the first link and the second link.

4. The cart according to claim 1, wherein the first side structure includes a stationary section fixed relative to the rear wall and a movable panel section that is pivotable relative to the stationary section about an axis.

5. The cart according to claim 1, wherein the braking system includes a brake mechanism and a brake actuator; and
wherein the link assembly transfers torque from the brake actuator to the brake mechanism to slow or stop rotation of the ground-engaging support element.

6. The cart according to claim 5, wherein the brake actuator is a brake pedal.

7. The cart according to claim 5, wherein the brake actuator rotates at least one link in the link assembly.

8. The cart according to claim 5, wherein the brake mechanism includes a plunger that is moved to apply a brake pad to the ground-engaging support element.

9. The cart according to claim 8, wherein the braking system includes a return device configured to bias the braking system toward an unbraked state.

10. The cart according to claim 5, wherein the first side structure includes a stationary section fixed relative to the rear wall and a movable panel section that is pivotable relative to the stationary section about an axis;
wherein the brake mechanism is a first brake mechanism coupled to the stationary section; and
wherein the braking system includes a second brake mechanism coupled to the panel section for selectively stopping the rotation of another ground-engaging support element.

11. The cart according to claim 1, wherein the link assembly includes a first rod, a second rod, and a joint connecting the first rod to the second rod.

12. The cart according to claim 11, wherein the joint includes a universal joint.

13. The cart according to claim 1, wherein the braking system includes a brake mechanism and the link assembly includes at least one link axially slidable through the brake mechanism.

14. The cart according to claim 13, wherein length of the at least one link extending from the brake mechanism increases as the link assembly is moved from the extended position toward the stored configuration.

15. The cart according to claim 1, further comprising at least one shelf supported on the rear wall and pivotable about a shelf axis between a lowered position for supporting objects thereon and a raised position adjacent the rear wall.

16. A cart for transporting objects, the cart comprising:
a rear wall;
a first side structure coupled to the rear wall, wherein the first side structure is movable to extend transverse to the rear wall when the cart is in a transport configuration and extend along the rear wall when the cart is in a stored configuration;
a pair of ground-engaging support elements coupled to the first side structure and configured to support the cart and permit movement of the cart;
a braking system for selectively stopping rotation of the ground-engaging support element to thereby prevent movement of the cart, the braking system including:
a link assembly having a first link and a second link coupled to each other with a joint, the link assembly being movable into and between:
an extended position in which the first link and the second link extend along an axis when the cart is in the transport configuration; and
a folded position in which the first link extends along the axis and the second link extends transverse to the axis when the cart is in the stored configuration;
a brake actuator coupled to the link assembly and operable to rotate the first link and/or the second link;
a first brake mechanism coupled to the first link such that rotation of the first link causes the first brake mechanism to stop rotation of one of the ground-engaging support elements; and
a second brake mechanism coupled to the second link such that rotation of the second link causes the second brake mechanism to stop rotation of the other ground-engaging support element.

17. The cart according to claim 16, wherein the joint is configured to allow for the transfer of rotation forces between the first link and the second link.

18. The cart according to claim 16, wherein the second link is axially slidable through the second brake mechanism.

19. A braking system for a foldable cart having a ground-engaging support element, a rear wall, and a side structure that is pivotable relative to the rear wall, the braking system comprising:
a link assembly including a first link, a second link, and a joint connecting the first link to the second link;
a first brake mechanism coupled to the first link and configured to selectively slow or stop rotation of the ground-engaging support element; and
a brake actuator configured to be selectively driven by an operator to thereby rotate the first link and/or the second link such that rotation of the first link causes the first brake mechanism to slow or stop rotation of the ground-engaging support element;
wherein the link assembly movable into and between:
an extended position in which the first link and the second link extend along an axis; and
a folded position in which the first link extends along the axis and the second link extends transverse to the axis.

20. The braking system according to claim 19, a second brake mechanism coupled to the second link and configured to selectively slow or stop the rotation of another ground-engaging support element of the cart.
